(19) United States
(12) Patent Application Publication
(10) Pub. No.: US 2023/0298138 A1
(43) Pub. Date: Sep. 21, 2023

(54) METHODS AND SYSTEMS FOR EXTRACTING MEDICAL IMAGES

(71) Applicant: Stryker Corporation, Kalamazoo, MI (US)

(72) Inventors: Jose GEORGE, Kollam (IN); Lina GUREVICH, Vancouver (CA)

(73) Assignee: Stryker Corporation, Kalamazoo, MI (US)

(21) Appl. No.: 18/183,929

(22) Filed: Mar. 14, 2023

Related U.S. Application Data
(60) Provisional application No. 63/269,398, filed on Mar. 15, 2022.

(51) Int. Cl. G06T 5/00; G06T 5/20; G06T 7/00; G06V 20/40; G06V 10/26

(52) U.S. Cl. CPC G06T 5/002; G06T 5/20; G06T 7/0012; G06V 20/44; G06V 10/273; G06T 2207/30104; G06T 2207/20201; G06T 2207/20081; G06T 2207/10016; G06T 2207/10068; G06V 2201/034

(57) ABSTRACT

The present disclosure relates generally to medical imaging, and more specifically to extracting a subset of images from a series of images (e.g., surgical video feeds) for training machine-learning models and/or conducting various downstream analyses. The system can hash image data for each image of a series of video images of the surgery to obtain a series of hash values; calculate a plurality of difference values for the series of hash values, each of the plurality of difference values indicative of a difference between two consecutive hash values in the series of hash values; generate a plurality of image clusters by clustering the plurality of distance values; select one or more image clusters from the plurality of image clusters; and produce a subset of surgical images from the series of video images using the selected one or more image clusters from the plurality of image clusters.

### CROSS-REFERENCE TO RELATED APPLICATIONS

This application claims the benefit of U.S. Provisional Application No. 63/269,398, filed Mar. 15, 2022, the entire contents of which are hereby incorporated by reference herein.

### FIELD

The present disclosure relates generally to medical imaging, and more specifically to extracting a subset of images from a series of images (e.g., surgical video feeds) for training machine-learning models and/or conducting various downstream analyses.

### BACKGROUND

Medical systems, instruments or tools are utilized pre-surgery, during surgery, or post-operatively for various purposes. Some of these medical tools may be used in what are generally termed endoscopic procedures or open field procedures. For example, endoscopy in the medical field allows internal features of the body of a patient to be viewed without the use of traditional, fully invasive surgery. Endoscopic imaging systems incorporate endoscopes to enable a surgeon to view a surgical site, and endoscopic tools enable minimally invasive surgery at the site. Such tools may be shaver-type devices which mechanically cut bone and hard tissue, or radio frequency (RF) probes which are used to remove tissue via ablation or to coagulate tissue to minimize bleeding at the surgical site, for example.

In endoscopic surgery, the endoscope is placed in the body at the location at which it is necessary to perform a surgical procedure. Other surgical instruments, such as the endoscopic tools mentioned above, are also placed in the body at the surgical site. A surgeon views the surgical site through the endoscope in order to manipulate the tools to perform the desired surgical procedure. Some endoscopes are usable along with a camera head for the purpose of processing the images received by the endoscope. An endoscopic camera system typically includes a camera head connected to a camera control unit (CCU) by a cable. The CCU processes input image data received from the image sensor of the camera via the cable and then outputs the image data for display. The resolution and frame rates of endoscopic camera systems are ever increasing and each component of the system must be designed accordingly.

Another type of medical imager that can include a camera head connected to a CCU by a cable is an open-field imager. Open-field imagers can be used to image open surgical fields, such as for visualizing blood flow in vessels and related tissue perfusion during plastic, microsurgical, reconstructive, and gastrointestinal procedures.

During a surgical operation, a large volume of image data (e.g., video data) may be collected. The image data can be useful for various downstream analyses and training machine-learning models. However, due to the large size and the duplicative nature of the image data, it may be inefficient to process and analyze the image data in its entirety. Accordingly, it would be desirable to extract only a subset of data from the original image data for further processing.

Conventional approaches to image extraction suffer from a number of deficiencies. For example, with a fixed frame rate approach, image frames are sampled at a predefined, constant temporal resolution. However, the fixed frame rate approach may lose relevant frames (e.g., maneuvering of surgical tools) occurring between samplings, and still result in duplicative images that may bias models and downstream analyses. As another example, machine-learning models have been implemented to extract a particular pattern or feature in video feeds. However, these machine-learning models are restricted to detecting predefined features and thus fail to capture features that are not predefined but may be nevertheless relevant for downstream analyses.

### SUMMARY

Disclosed herein are exemplary devices, apparatuses, systems, methods, and non-transitory storage media for medical image extraction. The systems, devices, and methods may be used to extract images from video data of a surgical operation, such as an endoscopic imaging procedure or an open field surgical imaging procedure. In some examples, the systems, devices, and methods may also be used to extract medical images from image data captured pre-operatively, post-operatively, and during diagnostic imaging sessions and procedures.

Examples of the present disclosure comprise automated de-duplication techniques with a variable frame rate for extracting images from a series of medical images (e.g., a surgical video feed). In the resulting extracted image set, replicative images that may bias downstream analyses or models are eliminated or reduced, but distinct images that capture potentially relevant actions (e.g., events during a surgical operation) are retained. The extracted images can improve various downstream analyses and the quality of machine-learning models trained using such data. As discussed herein, examples of the present disclosure provide variable image frame extraction using probabilistic modeling, which considers more images while an event occurs while minimizing similarity in image frames otherwise. The learning-based frame selection is superior to hard thresholding. The use of finite mixture models (“FMM”) provides a unique way to learn underlying parametric distribution and thus helps to provide better variable frame rate selection. Neighboring frames may be included through a spatial Markov Random Field (“MRF”) constraint. Further, examples of the present disclosure can maintain a target frame rate (e.g., specified by a user) and reduce motion blur and noise from the extracted images. Thus, techniques of the present disclosure ensure a generic way to extract relevant image frames by focusing more on frame-to-frame difference rather than on one feature alone in a single frame, ultimately providing effective selection of relevant frames while ensuring data variability.

An exemplary system can first obtain an image representation for each image of a series of images. The image representation represents feature context of an image in a generic manner. In some embodiments, the image representation is a hash value of the image. The system can then determine how different consecutive images in the series of images are, for example, by calculating difference values where each difference value is indicative of the difference between the hash values of two consecutive images in the series of images. The system then performs a smooth selection of images using probabilistic modeling of image hash difference values to select images based on the underlying distribution of difference values, which ensures variability in the selected images while minimizing the similarity between images. For example, the system generates a plurality of image clusters by clustering the difference values. To cluster the plurality of difference values, the system fits a finite mixture model using an expectation-maximization (“EM”) algorithm to learn the underlying parametric distribution using unsupervised-learning techniques. MRF constraint may be used for neighborhood dependency enabling a smooth transition from one frame onto other, rather than using a hard cut-off from cluster occupancy. MRF helps to provide a type of temporal modeling, because of which neighboring predictions tend to remain similar. It allows for a smooth gradation of cluster occupancy instead of sharp shifts. Finally, the system can select one or more image clusters from the plurality of image clusters (e.g., based on a target frame rate) and produce a subset of surgical images using the selected one or more image clusters.

In some examples, the subset of images obtained by examples of the present disclosure can be used to train a machine-learning model. The machine-learning model can be any machine-learning model that is configured to receive one or more surgical images and provide an output, such as a machine-learning model configured to receive a surgical image and detect objects and/or events in the surgical image. Rather than using all images of a video to train the model, only a subset of images needs to be provided to the machine-learning model to train the model. The subset of images may be equally or more effective at training the model because it includes the representative images in the video without including duplicative images to create bias in the model. At the same time, the required time, the processing power, and the computer memory to train the model can be significantly reduced due to the smaller number of training images. In some examples, the deduplication process can be used for data reduction and missing frames can be generated from reduced data using generative models.

In some examples, the subset of images obtained by examples of the present disclosure can be processed by an algorithm to analyze the surgical operation. Rather than providing an entire video stream to the algorithm, only the subset of images can be provided to the algorithm. The subset of images does not compromise the quality of the analysis because it includes the representative images in the original video. At the same time, the required time, the processing power, and the computer memory to conduct the analysis can be significantly reduced due to the smaller number of images that need to be processed.

In some examples, an algorithm can be used to process the subset of images and automatically identify events depicted in the subset of images. The system can then store an association between a given event and the timestamp of the image(s) depicting the given event for a later lookup. For example, a surgeon may want to review at a particular event or phase of surgery (e.g., a critical view of safety in laparoscopic cholecystectomy). Based on the event, the system can identify the timestamp(s) associated with the event and retrieve the image(s) for a quick review rather than requiring the surgeon to view the entire video to find the event.

In some examples, the subset of images obtained by examples of the present disclosure can be displayed on a display. If a medical practitioner would like to review a surgery, he or she can simply review the subset of images (e.g., as a shorter series of images or as a shortened video). Accordingly, the review time can be significantly reduced without compromising the thoroughness of the review.

While some examples of the present disclosure involve processing a series of images to obtain a subset of images, it should be appreciated that the examples of the present disclosure can be applied to process a series of videos to obtain a subset of videos. In some examples, examples of the present disclosure can be performed real time during a surgery. The extracted subset of images can be saved locally for display and/or uploaded through a network for downstream analyses (e.g., training machine-learning models).

According to some aspects, an exemplary method for obtaining a subset of surgical images from a series of video images of a surgery comprises: hashing image data for each image of the series of video images of the surgery to obtain a series of hash values; calculating a plurality of difference values for the series of hash values, each of the plurality of difference values indicative of a difference between two consecutive hash values in the series of hash values; generating a plurality of image clusters by clustering the plurality of difference values; selecting one or more image clusters from the plurality of image clusters; and producing the subset of surgical images from the series of video images using the selected one or more image clusters from the plurality of image clusters.

According to some aspects, the series of video images is captured by an endoscopic imaging system.

According to some aspects, the series of video images is captured by an open-field imaging system.

According to some aspects, the subset of surgical images includes an image depicting an event in the surgery.

According to some aspects, the subset of surgical images includes a single image depicting the event in the surgery.

According to some aspects, the event comprises: introduction of a surgical tool, removal of the surgical tool, movement of the surgical tool, identification of anatomical landmarks during surgery, critical view of safety in laparoscopic cholecystectomy, identification of critical structures during surgery, removal of organs, navigating through tissue structures as part of preparation, monitoring suture, checking for extravasation or leakage (blood, bile, or other fluids), cauterization, clipping, cutting, or any combination thereof.

According to some aspects, the method further comprises: training a machine-learning model based on the subset of surgical images from the series of video images.

According to some aspects, the machine-learning model is a generative model, the method further comprising: generating one or more images using the trained machine-learning model.

According to some aspects, the method further comprises: displaying the subset of surgical images from the series of video images.

According to some aspects, the method further comprises: detecting an event in an image in the subset of surgical images; and storing a timestamp associated with the image.

According to some aspects, each hash value of the series of hash values is an N-bit binary representation.

According to some aspects, hashing image data for each image of the series of video images of the surgery comprises: reducing the resolution of each image in the series of video images; and after reducing the resolution, applying a hash algorithm to the image to obtain a corresponding hash value.

According to some aspects, the hash algorithm comprises: an average hash algorithm, a difference hash algorithm, a perceptual hash algorithm, a wavelet hash algorithm, a locality-sensitive hash algorithm, or any combination thereof.

According to some aspects, each difference value of the plurality of difference values is a Hamming distance.

According to some aspects, the Hamming distance between two hash values is computed by performing a bit-wise OR operation between the two hash values.

According to some aspects, clustering the plurality of difference values comprises performing probabilistic clustering, K-means clustering, fuzzy C-means clustering, mean-shift clustering, hierarchical clustering, or any combination thereof.

According to some aspects, performing probabilistic clustering comprises performing unsupervised learning of finite mixture models (FMMs).

According to some aspects, performing probabilistic clustering comprises: (A) performing an expectation step to obtain an a posteriori probability for each cluster of a predefined number of clusters; (B) performing a maximization step to obtain one or more parameters for each cluster of the predefined number of clusters; and (C) repeating steps (A)-(B) until a convergence is reached.

According to some aspects, the one or more parameters comprises one or more distribution parameters.

According to some aspects, performing the maximization step further comprises calculating one or more prior probability values for each cluster of the predefined number of clusters.

According to some aspects, the one or more prior probability values include a spatial Markov Random Field (“MRF”) prior estimated from a posterior probability.

According to some aspects, selecting one or more image clusters from the plurality of image clusters comprises: assigning each difference value of the plurality of difference values to one of the plurality of image clusters based on the maximum a posteriori (MAP) rule; and ordering the plurality of image clusters.

According to some aspects, the first image of the series of video images is included in the subset of surgical images by default.

According to some aspects, the method further comprises: receiving a minimum frame selection window; and including one or more images from an unselected image cluster to the subset of surgical images based on the minimum frame selection window.

According to some aspects, the method further comprises: determining whether an image in the subset of surgical images comprises a motion artifact or noise.

According to some aspects, the method further comprises: in accordance with a determination that the image comprises a motion artifact or noise, removing the image from the subset of surgical images.

According to some aspects, the method further comprises: in accordance with a determination that the image comprises a motion artifact or noise, repairing the image.

According to some aspects, the method further comprises: in accordance with a determination that the image comprises a motion artifact or noise, including the image in the subset of surgical images.

According to some aspects, a system for obtaining a subset of surgical images from a series of video images of a surgery comprises: one or more processors; one or more memories; and one or more programs, wherein the one or more programs are stored in the one or more memories and configured to be executed by the one or more processors, the one or more programs including instructions for: hashing image data for each image of the series of video images of the surgery to obtain a series of hash values; calculating a plurality of difference values for the series of hash values, each of the plurality of difference values indicative of a difference between two consecutive hash values in the series of hash values; generating a plurality of image clusters by clustering the plurality of difference values; selecting one or more image clusters from the plurality of image clusters; and producing the subset of surgical images from the series of video images using the selected one or more image clusters from the plurality of image clusters.

According to some aspects, the series of video images is captured by an endoscopic imaging system.

According to some aspects, the series of video images is captured by an open-field imaging system.

According to some aspects, the subset of surgical images includes an image depicting an event in the surgery.

According to some aspects, the subset of surgical images includes a single image depicting the event in the surgery.

According to some aspects, the event comprises: introduction of a surgical tool, removal of the surgical tool, movement of the surgical tool, identification of anatomical landmarks during surgery, critical view of safety in laparoscopic cholecystectomy, identification of critical structures during surgery, removal of organs, navigating through tissue structures as part of preparation, monitoring suture, checking for extravasation or leakage (blood, bile, or other fluids), cauterization, clipping, cutting, or any combination thereof.

According to some aspects, the one or more programs further include instructions for: training a machine-learning model based on the subset of surgical images from the series of video images.

According to some aspects, the machine-learning model is a generative model, the system further comprising: generating one or more images using the trained machine-learning model.

According to some aspects, the one or more programs further include instructions for: displaying the subset of surgical images from the series of video images.

According to some aspects, the one or more programs further include instructions for detecting an event in an image in the subset of surgical images; and storing a timestamp associated with the image.

According to some aspects, each hash value of the series of hash values is an N-bit binary representation.

According to some aspects, hashing image data for each image of the series of video images of the surgery comprises: reducing the resolution of each image in the series of video images; and after reducing the resolution, applying a hash algorithm to the image to obtain a corresponding hash value.

According to some aspects, the hash algorithm comprises: an average hash algorithm, a difference hash algorithm, a perceptual hash algorithm, a wavelet hash algorithm, a locality-sensitive hash algorithm, or any combination thereof.

According to some aspects, each difference value of the plurality of difference values is a Hamming distance.

According to some aspects, the Hamming distance between two hash values is computed by performing a bit-wise OR operation between the two hash values.

According to some aspects, clustering the plurality of difference values comprises performing probabilistic clustering, K-means clustering, fuzzy C-means clustering, mean-shift clustering, hierarchical clustering, or any combination thereof.

According to some aspects, performing probabilistic clustering comprises performing unsupervised learning of finite mixture models (FMMs).

According to some aspects, performing probabilistic clustering comprises: (A) performing an expectation step to obtain an a posteriori probability for each cluster of a predefined number of clusters; (B) performing a maximization step to obtain one or more parameters for each cluster of the predefined number of clusters; and (C) repeating steps (A)-(B) until a convergence is reached.

According to some aspects, the one or more parameters comprises one or more distribution parameters.

According to some aspects, performing the maximization step further comprises calculating one or more prior probability values for each cluster of the predefined number of clusters.

According to some aspects, the one or more prior probability values include a spatial Markov Random Field (“MRF”) prior estimated from a posterior probability.

According to some aspects, selecting one or more image clusters from the plurality of image clusters comprises: assigning each difference value of the plurality of difference values to one of the plurality of image clusters based on the maximum a posteriori (MAP) rule; and ordering the plurality of image clusters.

According to some aspects, the first image of the series of video images is included in the subset of surgical images by default.

According to some aspects, the one or more programs further include instructions for: receiving a minimum frame selection window; and including one or more images from an unselected image cluster to the subset of surgical images based on the minimum frame selection window.

According to some aspects, the one or more programs further include instructions for: determining whether an image in the subset of surgical images comprises a motion artifact or noise.

According to some aspects, the one or more programs further include instructions for: in accordance with a determination that the image comprises a motion artifact or noise, removing the image from the subset of surgical images.

According to some aspects, the one or more programs further include instructions for: in accordance with a determination that the image comprises a motion artifact or noise, repairing the image.

According to some aspects, the one or more programs further include instructions for: in accordance with a determination that the image comprises a motion artifact or noise, including the image in the subset of surgical images.

According to some aspects, non-transitory computer-readable storage medium stores one or more programs, the one or more programs comprising instructions, which when executed by one or more processors of an electronic device, cause the electronic device to perform any of methods described herein.

According to an aspect is provided a computer program product comprising instructions, which when executed by one or more processors of an electronic device, cause the electronic device to perform any of the techniques described herein. An exemplary non-transitory computer-readable storage medium stores one or more programs, the one or more programs comprising instructions, which when executed by one or more processors of an electronic device, cause the electronic device to perform any of the techniques described herein.

It will be appreciated that any one or more of the above aspects, examples, features and options can be combined. It will be appreciated that any one of the options described in view of one of the aspects can be applied equally to any of the other aspects. It will also be clear that all aspects, features and options described in view of the methods apply equally to the devices, apparatuses, systems, non-transitory storage media and computer program products, and vice versa.

### BRIEF DESCRIPTION OF THE FIGURES

The invention will now be described, by way of example only, with reference to the accompanying drawings, in which:

FIG. 1A is an illustration of an endoscopic camera system, according to some examples;

FIG. 1B is a diagram of a portion of the endoscopic camera system of FIG. 1A and a target object for imaging, according to some examples;

FIG. 2 illustrates a schematic view of a system for illumination and imaging according to some examples;

FIG. 3 is a block diagram of an imaging system, according to some examples;

FIG. 4 illustrates an exemplary method for obtaining a subset of surgical images from a series of video images of a surgery, according to some examples;

FIG. 5 illustrates exemplary inputs and the corresponding exemplary outputs of the process 400, in accordance with some examples;

FIG. 6 illustrates exemplary inputs and outputs of various steps in the process 400, in accordance with some examples; and

FIG. 7 illustrates an exemplary process for performing probabilistic modeling or EM algorithm for unsupervised learning of finite mixture models, in accordance with some examples.

### DETAILED DESCRIPTION

Reference will now be made in detail to implementations and various aspects and variations of systems and methods described herein. Although several exemplary variations of the systems and methods are described herein, other variations of the systems and methods may include aspects of the systems and methods described herein combined in any suitable manner having combinations of all or some of the aspects described. Examples will now be described more fully hereinafter with reference to the accompanying drawings; however, they may be embodied in different forms and should not be construed as limited to the examples set forth herein. Rather, these examples are provided so that this disclosure will be thorough and complete, and will fully convey exemplary implementations to those skilled in the art.

Disclosed herein are exemplary devices, apparatuses, systems, methods, and non-transitory storage media for medical image extraction. The systems, devices, and methods may be used to extract images from video data of a surgical operation, such as an endoscopic imaging procedure or an open field surgical imaging procedure. In some examples, the systems, devices, and methods may also be used to extract medical images from image data captured pre-operatively, post-operatively, and during diagnostic imaging sessions and procedures.

Examples of the present disclosure comprise automated de-duplication techniques with a variable frame rate for extracting images from a series of medical images (e.g., a surgical video feed). In the resulting extracted image set, replicative images that may bias downstream analyses or models are eliminated or reduced, but distinct images that capture potentially relevant actions (e.g., events during a surgical operation) are retained. The extracted images can improve various downstream analyses and the quality of machine-learning models trained using such data. As discussed herein, examples of the present disclosure provide variable image frame extraction using probabilistic modeling, which considers more images while an event occurs while minimizing similarity in image frames otherwise. The learning-based frame selection is superior to hard thresholding. The use of finite mixture models (“FMM”) provides a unique way to learn underlying parametric distribution and thus helps to provide better variable frame rate selection. Neighboring frames may be included through a spatial Markov Random Field (“MRF”) constraint. Further, examples of the present disclosure can maintain a target frame rate (e.g., specified by a user) and reduce motion blur and noise from the extracted images. Thus, techniques of the present disclosure ensure a generic way to extract relevant image frames by focusing more on frame-to-frame difference rather than on one feature alone in a single frame, ultimately providing effective selection of relevant frames while ensuring data variability.

An exemplary system can first obtain an image representation for each image of a series of images. The image representation represents feature context of an image in a generic manner. In some embodiments, the image representation is a hash value of the image. The system can then determine how different consecutive images in the series of images are, for example, by calculating difference values where each difference value is indicative of the difference between the hash values of two consecutive images in the series of images. The system then performs a smooth selection of images using probabilistic modeling of image hash difference values to select images based on the underlying distribution of difference values, which ensures variability in the selected images while minimizing the similarity between images. For example, the system generates a plurality of image clusters by clustering the difference values. To cluster the plurality of difference values, the system fits a finite mixture model using an expectation-maximization (“EM”) algorithm to learn the underlying parametric distribution using unsupervised-learning techniques. MRF constraint may be used for neighborhood dependency enabling a smooth transition from one frame onto other, rather than using a hard cut-off from cluster occupancy. MRF helps to provide a type of temporal modeling, because of which neighboring predictions tend to remain similar. It allows for a smooth gradation of cluster occupancy instead of sharp shifts. Finally, the system can select one or more image clusters from the plurality of image clusters (e.g., based on a target frame rate) and produce a subset of surgical images using the selected one or more image clusters.

The subset of images obtained by examples of the present disclosure can be used to train a machine-learning model. The machine-learning model can be any machine-learning model that is configured to receive one or more surgical images and provide an output, such as a machine-learning model configured to receive a surgical image and detect objects and/or events in the surgical image. Rather than using all images of a video to train the model, only a subset of images needs to be provided to the machine-learning model to train the model. The subset of images may be equally or more effective at training the model because it includes the representative images in the video without including duplicative images to create bias in the model. At the same time, the required time, the processing power, and the computer memory to train the model can be significantly reduced due to the smaller number of training images. In some examples, the deduplication process can be used for data reduction and missing frames can be generated from reduced data using generative models.

Alternatively, or additionally, the subset of images obtained by examples of the present disclosure can be processed by an algorithm to analyze the surgical operation. Rather than providing an entire video stream to the algorithm, only the subset of images can be provided to the algorithm. The subset of images does not compromise the quality of the analysis because it includes the representative images in the original video. At the same time, the required time, the processing power, and the computer memory to conduct the analysis can be significantly reduced due to the smaller number of images that need to be processed.

An algorithm can be used to process the subset of images and automatically identify events depicted in the subset of images. The system can then store an association between a given event and the timestamp of the image(s) depicting the given event for a later lookup. For example, a surgeon may want to review at a particular event or phase of surgery (e.g., a critical view of safety in laparoscopic cholecystectomy). Based on the event, the system can identify the timestamp(s) associated with the event and retrieve the image(s) for a quick review rather than requiring the surgeon to view the entire video to find the event.

The subset of images obtained by examples of the present disclosure can be displayed on a display. If a medical practitioner would like to review a surgery, he or she can simply review the subset of images (e.g., as a shorter series of images or as a shortened video). Accordingly, the review time can be significantly reduced without compromising the thoroughness of the review.

While some examples of the present disclosure involve processing a series of images to obtain a subset of images, it should be appreciated that the examples of the present disclosure can be applied to process a series of videos to obtain a subset of videos. In some examples, examples of the present disclosure can be performed real time during a surgery. The extracted subset of images can be saved locally for display and/or uploaded through a network for downstream analyses (e.g., training machine-learning models).

In the following description, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some examples also relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein.

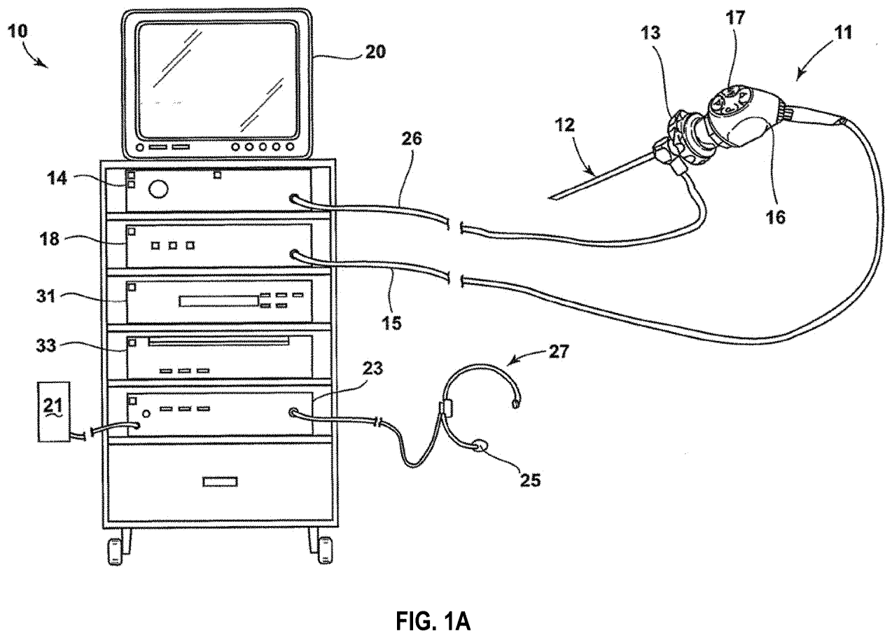

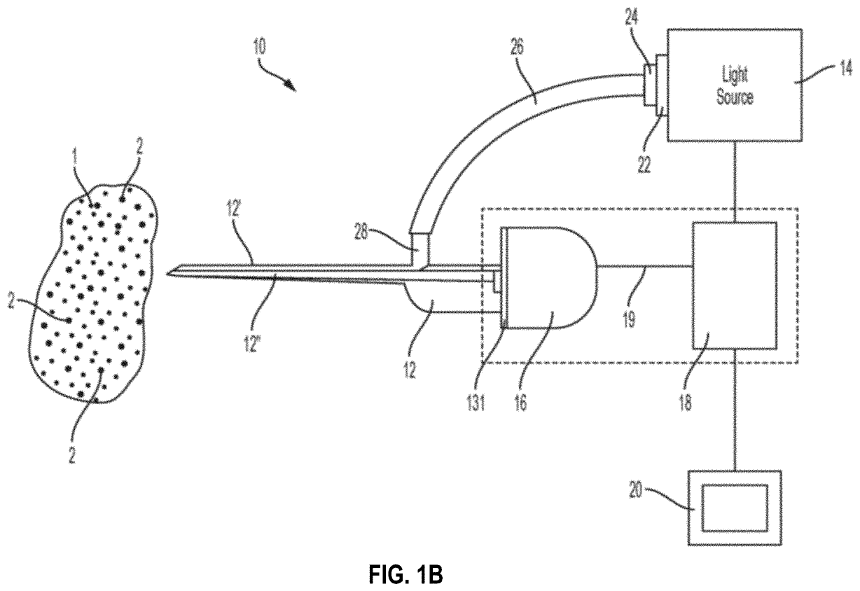

FIG. 1A shows an example of an endoscopic imaging system 10, which includes a scope assembly 11 which may be utilized in endoscopic procedures. The scope assembly 11 incorporates an endoscope or scope 12 which is coupled to a camera head 16 by a coupler 13 located at the distal end of the camera head 16. Light is provided to the scope by a light source 14 via a light guide 26, such as a fiber optic cable. The camera head 16 is coupled to a camera control unit (CCU) 18 by an electrical cable 15. The CCU 18 is connected to, and communicates with, the light source 14. Operation of the camera 16 is controlled, in part, by the CCU 18. The cable 15 conveys video image and/or still image data from the camera head 16 to the CCU 18 and may convey various control signals bi-directionally between the camera head 16 and the CCU 18.

A control or switch arrangement 17 may be provided on the camera head 16 for allowing a user to manually control various functions of the system 10, which may include switching from one imaging mode to another, as discussed further below. Voice commands may be input into a microphone 25 mounted on a headset 27 worn by the practitioner and coupled to the voice-control unit 23. A hand-held control device 29, such as a tablet with a touch screen user interface or a PDA, may be coupled to the voice control unit 23 as a further control interface. In the illustrated example, a recorder 31 and a printer 33 are also coupled to the CCU 18. Additional devices, such as an image capture and archiving device, may be included in the system 10 and coupled to the CCU 18. Video image data acquired by the camera head 16 and processed by the CCU 18 is converted to images, which can be displayed on a monitor 20, recorded by recorder 31, and/or used to generate static images, hard copies of which can be produced by the printer 33.

FIG. 1B shows an example of a portion of the endoscopic system 10 being used to illuminate and receive light from an object 1, such as a surgical site of a patient. The endoscope 12 may be pre-inserted into a cavity prior to obtaining the image data. The object 1 may include fluorescent markers 2, for example, as a result of the patient being administered a fluorescence imaging agent. The fluorescence imaging agent may be pre-administered prior to obtaining the image data. The fluorescent markers 2 may comprise, for example, indocyanine green (ICG).

The light source 14 can generate visible illumination light (such as any combination of red, green, and blue light) for generating visible (e.g., white light) images of the target object 1 and, in some examples, can also produce fluorescence excitation illumination light for exciting the fluorescent markers 2 in the target object for generating fluorescence images. Illumination light is transmitted to and through an optic lens system 22 which focuses light onto a light pipe 24. The light pipe 24 may create a homogeneous light, which is then transmitted to the fiber optic light guide 26. The light guide 26 may include multiple optic fibers and is connected to a light post 28, which is part of the endoscope 12. The endoscope 12 includes an illumination pathway 12′ and an optical channel pathway 12″.

The endoscope 12 may include a notch filter 131 that allows some or all (preferably, at least 80%) of fluorescence emission light (e.g., in a wavelength range of 830 nm to 870 nm) emitted by fluorescence markers 2 in the target object 1 to pass therethrough and that allows some or all (preferably, at least 80%) of visible light (e.g., in the wavelength range of 400 nm to 700 nm), such as visible illumination light reflected by the target object 1, to pass therethrough, but that blocks substantially all of the fluorescence excitation light (e.g., infrared light having a wavelength of 808 nm) that is used to excite fluorescence emission from the fluorescent marker 2 in the target object 1. The notch filter 131 may have an optical density of OD5 or higher. In some examples, the notch filter 131 can be located in the coupler 13.

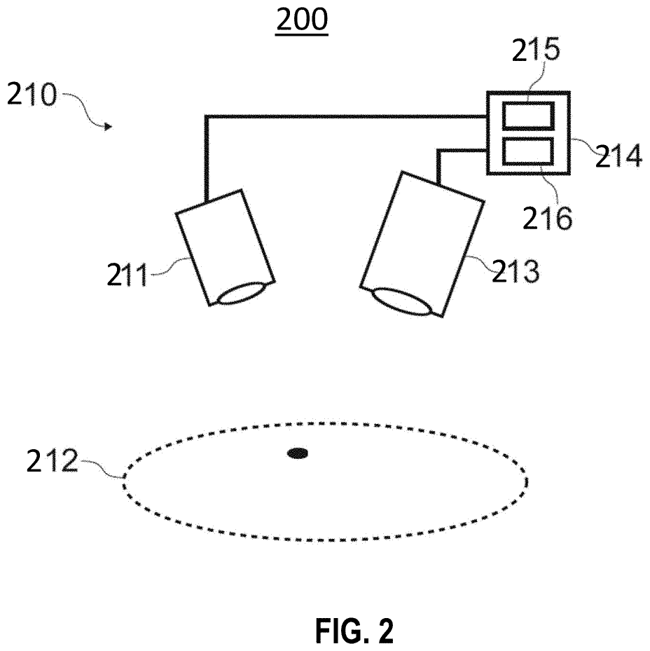

FIG. 2 illustrates an exemplary open field imaging system in accordance with some examples. FIG. 2 illustrates a schematic view of an illumination and imaging system 210 that can be used in open field surgical procedures. As may be seen therein, the system 210 may include an illumination module 211, an imaging module 213, and a video processor/illuminator (VPI) 214. The VPI 214 may include an illumination source 215 to provide illumination to the illumination module 211 and a processor assembly 216 to send control signals and to receive data about light detected by the imaging module 213 from a target 212 illuminated by light output by the illumination module 211. In one variation, the video processor/illuminator 214 may comprise a separately housed illumination source 215 and the processor assembly 216. In one variation, the video processor/illuminator 214 may comprise the processor assembly 216 while one or more illumination sources 215 are separately contained within the housing of the illumination module 211. The illumination source 215 may output light at different waveband regions, e.g., white (RGB) light, excitation light to induce fluorescence in the target 212, a combination thereof, and so forth, depending on characteristics to be examined and the material of the target 212. Light at different wavebands may be output by the illumination source 215 simultaneously, sequentially, or both. The illumination and imaging system 210 may be used, for example, to facilitate medical (e.g., surgical) decision making e.g., during a surgical procedure. The target 212 may be a topographically complex target, e.g., a biological material including tissue, an anatomical structure, other objects with contours and shapes resulting in shadowing when illuminated, and so forth. The VPI 214 may record, process, display, and so forth, the resulting images and associated information.

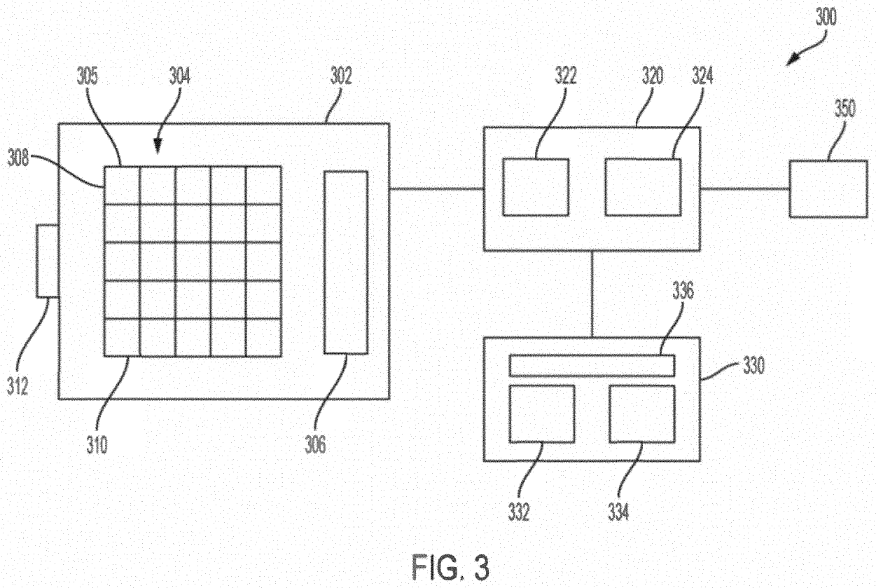

FIG. 3 schematically illustrates an exemplary imaging system 300 that employs an electronic imager 302 to generate images (e.g., still and/or video) of a target object, such as a target tissue of a patient, according to some examples. The imager 302 may be a rolling shutter imager (e.g., CMOS sensors) or a global shutter imager (e.g., CCD sensors). System 300 may be used, for example, for the endoscopic imaging system 10 of FIG. 1A. The imager 302 includes a CMOS sensor 304 having an array of pixels 305 arranged in rows of pixels 308 and columns of pixels 310. The imager 302 may include control components 306 that control the signals generated by the CMOS sensor 304. Examples of control components include gain circuitry for generating a multi-bit signal indicative of light incident on each pixel of the sensor 304, one or more analog-to-digital converters, one or more line drivers to act as a buffer and provide driving power for the sensor 304, row circuitry, and timing circuitry. A timing circuit may include components such as a bias circuit, a clock/timing generation circuit, and/or an oscillator. Row circuitry may enable one or more processing and/or operational tasks such as addressing rows of pixels 308, addressing columns of pixels 310, resetting charge on rows of pixels 308, enabling exposure of pixels 305, decoding signals, amplifying signals, analog-to-digital signal conversion, applying timing, read out and reset signals and other suitable processes or tasks. Imager 302 may also include a mechanical shutter 312 that may be used, for example, to control exposure of the image sensor 304 and/or to control an amount of light received at the image sensor 304.

One or more control components may be integrated into the same integrated circuit in which the sensor 304 is integrated or may be discrete components. The imager 302 may be incorporated into an imaging head, such as camera head 16 of system 10.

One or more control components 306, such as row circuitry and a timing circuit, may be electrically connected to an imaging controller 320, such as camera control unit 18 of system 10. The imaging controller 320 may include one or more processors 322 and memory 324. The imaging controller 320 receives imager row readouts and may control readout timings and other imager operations, including mechanical shutter operation. The imaging controller 320 may generate image frames, such as video frames from the row and/or column readouts from the imager 302. Generated frames may be provided to a display 350 for display to a user, such as a surgeon.

The system 300 in this example includes a light source 330 for illuminating a target scene. The light source 330 is controlled by the imaging controller 320. The imaging controller 320 may determine the type of illumination provided by the light source 330 (e.g., white light, fluorescence excitation light, or both), the intensity of the illumination provided by the light source 330, and or the on/off times of illumination in synchronization with rolling shutter operation. The light source 330 may include a first light generator 332 for generating light in a first wavelength and a second light generator 334 for generating light in a second wavelength. In some examples, the first light generator 332 is a white light generator, which may be comprised of multiple discrete light generation components (e.g., multiple LEDs of different colors), and the second light generator 334 is a fluorescence excitation light generator, such as a laser diode.

The light source 330 includes a controller 336 for controlling light output of the light generators. The controller 336 may be configured to provide pulse width modulation of the light generators for modulating intensity of light provided by the light source 330, which can be used to manage over-exposure and under-exposure. In some examples, nominal current and/or voltage of each light generator remains constant and the light intensity is modulated by switching the light generators (e.g., LEDs) on and off according to a pulse width control signal. In some examples, a PWM control signal is provided by the imaging controller 336. This control signal can be a waveform that corresponds to the desired pulse width modulated operation of light generators.

The imaging controller 320 may be configured to determine the illumination intensity required of the light source 330 and may generate a PWM signal that is communicated to the light source 330. In some examples, depending on the amount of light received at the sensor 304 and the integration times, the light source may be pulsed at different rates to alter the intensity of illumination light at the target scene. The imaging controller 320 may determine a required illumination light intensity for a subsequent frame based on an amount of light received at the sensor 304 in a current frame and/or one or more previous frames. In some examples, the imaging controller 320 is capable of controlling pixel intensities via PWM of the light source 330 (to increase/decrease the amount of light at the pixels), via operation of the mechanical shutter 312 (to increase/decrease the amount of light at the pixels), and/or via changes in gain (to increase/decrease sensitivity of the pixels to received light). In some examples, the imaging controller 320 primarily uses PWM of the illumination source for controlling pixel intensities while holding the shutter open (or at least not operating the shutter) and maintaining gain levels. The controller 320 may operate the shutter 312 and/or modify the gain in the event that the light intensity is at a maximum or minimum and further adjustment is needed.

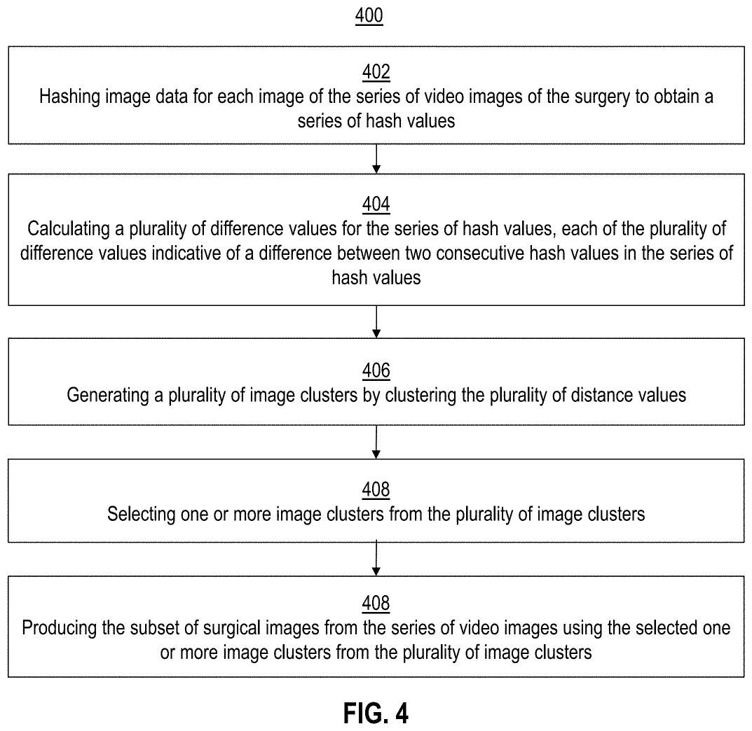

FIG. 4 illustrates an exemplary method 400 for obtaining a subset of surgical images from a series of video images of a surgery, according to some examples. Process 400 is performed, for example, using one or more electronic devices implementing a software platform. In some examples, process 400 is performed using a client-server system, and the blocks of process 400 are divided up in any manner between the server and one or more client devices. In some examples, process 400 is performed using only a client device or only multiple client devices. In process 400, some blocks are, optionally, combined, the order of some blocks is, optionally, changed, and some blocks are, optionally, omitted. In some examples, additional steps may be performed in combination with the process 400. Accordingly, the operations as illustrated (and described in greater detail below) are exemplary by nature and, as such, should not be viewed as limiting.

By performing process 400, the system eliminates replicative images from a series of video images, while retaining images that capture events during a surgical operation that may be relevant for downstream analyses. The series of video images processed by process 400 can be from a video captured during a surgical operation. In some examples, the series of video images is at least a segment of a video captured by an endoscopic imaging system. In some examples, the series of video images is at least a segment of a video captured by an open-field imaging system. As described in detail below, the process 400 can process the series of video images to obtain a subset of surgical images from the series of video images. In some examples, for a particular event in the surgery, the subset of surgical images obtained using process 400 includes a single image or a limited number of images depicting the event in the surgery. The event can comprise: introduction of a surgical tool, removal of the surgical tool, movement of the surgical tool, identification of anatomical landmarks during surgery, critical view of safety in laparoscopic cholecystectomy, identification of critical structures during surgery, removal of organs (e.g., gallbladder removal), navigating through tissue structures as part of preparation, monitoring suture, checking for extravasation or leakage (blood, bile, or other fluids), cauterization, clipping, cutting, or any combination thereof.

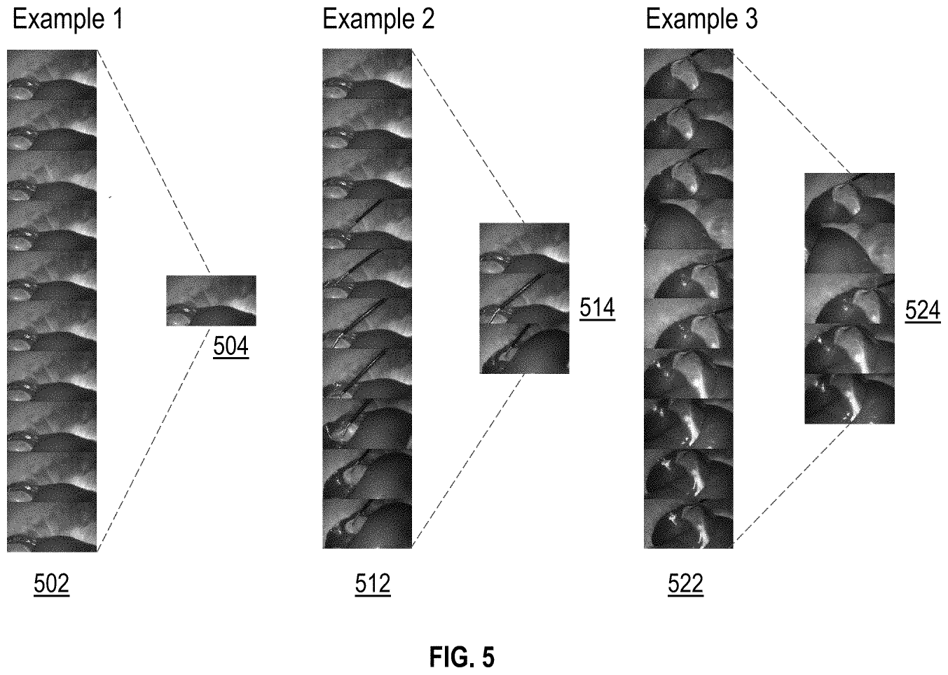

FIG. 5 illustrates exemplary inputs and the corresponding exemplary outputs of the process 400, in accordance with some examples. In the first example, a system can receive a series of video images 502 as the input and extract an image 504 as the output. In the second example, the system can receive a series of video images 512 as the input and extract a subset of the video images 514 as the output. In the third example, the system can receive a series of video images 522 as the input and extract a subset of the video images 524 as the output.

As shown in FIG. 5, the system eliminates replicative images while retaining images that capture events during a surgical operation. In the first example, all images in the series of video images 502 depict a static surgical site; accordingly, the system extracts only one representative image 504 from the series as the output. In the second example, the series of video images 512 shows a static surgical site, followed by introduction of a surgical tool at the surgical site, and followed by maneuvering of the surgical tool at the surgical site; accordingly, the system extracts a representative image showing the static surgical site, a representative image showing the introduction of the surgical tool, and a representative image showing the maneuvering of the surgical tool as the output. Similarly, in the third example, duplicative images are removed, while images that capture events such as appearance, disappearance, and reappearance of a surgical tool and maneuvering of the surgical tool are extracted.

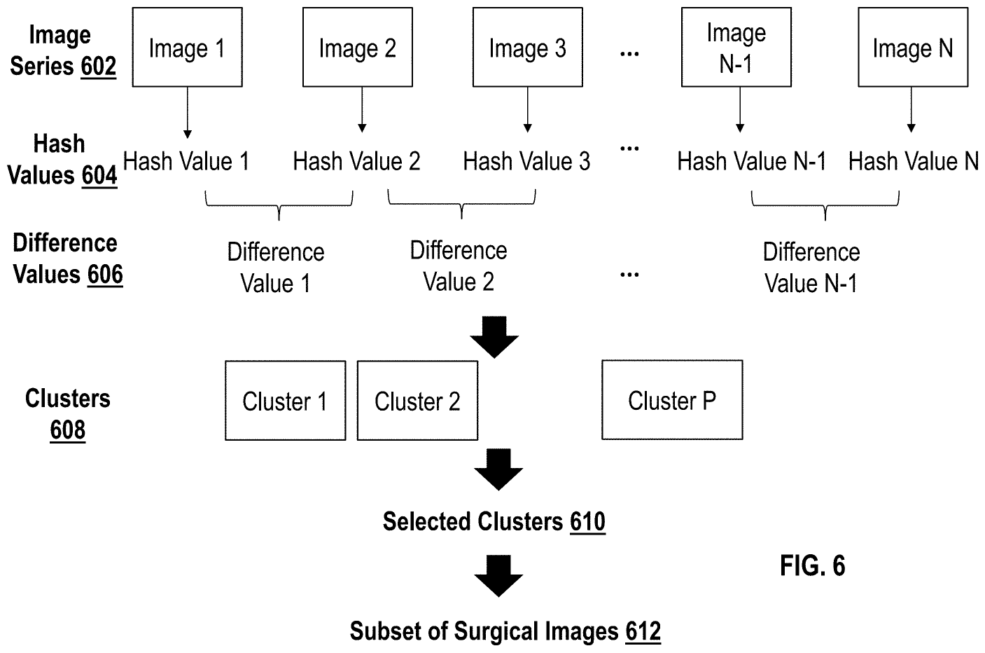

Turning back to FIG. 4, at block 402, an exemplary system (e.g., one or more electronic devices) hashes image data for each image of the series of video images of the surgery to obtain a series of hash values. An exemplary input and the corresponding exemplary output of the block 402 are shown in FIG. 6. As shown, the system obtains a series of video images 1−N (i.e., image series 602), which may be at least a segment of a surgical video (e.g., 502, 512, and 522 in FIG. 5). The system then hashes Image 1 to obtain Hash Value 1, Image 2 to obtain Hash Value 2, . . . and Image N to obtain Hash Value N, thus obtaining a series of hash values 604.

A hash value is a representation or fingerprint of the corresponding image. In some examples, a hash value is an N-bit binary representation of an image. The advantage of obtaining hash values and analyzing the obtained hash values, rather than analyzing the images themselves, is that hashing creates a representation of an image that has low variance (e.g., low distance value for Hamming distance) even if the image is perturbed with noise, blur (e.g., motion blur), or other transforms such as shift, rotation, etc. Any suitable hashing algorithm, for example, in the spatial domain, in the frequency domain, or based on other transformations, can be used to obtain the hash value. In some examples, the hash algorithm comprises: an average hash algorithm, a difference hash algorithm, a perceptual hash algorithm, a wavelet hash algorithm, a locality-sensitive hash algorithm, or any combination thereof. In some examples, a suitable hashing algorithm can be selected based on a targeted invariance property.

Average hash (aHash) and difference hash (dHash) are calculated from the spatial domain. With aHash, for each pixel, the system outputs 1 if the pixel is greater than or equal to average and 0 otherwise. With dHash, the system computes gradients and outputs 1 if the pixel is greater than next and 0 otherwise. Perceptual hash (pHash) and wavelet hash (wHash) are derived from the frequency domain. With pHash, the system finds discrete cosine transform (DCT) of an image and computes aHash of the DCT. With wHash, the system finds discrete wavelet transform (DWT) of an image and computes aHash of the DWT. Locality-sensitive hashing (1Hash) is an alternate with hybrid representation of both. With 1Hash, the system computes a quantized color histogram of an image as an RGB signature, and outputs 1 if that normalized histogram is above a predefined set of planes and 0 otherwise.

In some examples, before image hashing, the input image is rescaled to a lower resolution in a pre-processing step. For example, the system first reduces the resolution of each image in the series of video images and, after reducing the resolution, applies a hash algorithm to the image to obtain a corresponding hash value.

At block 404, the system calculates a plurality of difference values for the series of hash values, each of the plurality of difference values indicative of a difference between two consecutive hash values in the series of hash values. With reference to FIG. 6, the system calculates Difference Value 1 indicative of a difference between Hash Value 1 and Hash Value 2 and associated with Hash Value 2, Difference Value 2 indicative of a difference between Hash Value 2 and Hash Value 3 and associated with Hash Value 3, . . . , and a difference value N−1 indicative of a difference between Hash Value N−1 and Hash Value N and associated with Hash Value N, thus obtaining difference values 1 to (N−1).

In some examples, each difference value of the plurality of difference values is a Hamming distance. In some examples, the Hamming distance between two hash values is computed by performing a bit-wise OR operation between the two hash values. However, it should be appreciated that other suitable algorithms can be used to calculate a value indicative of a difference or distance between two hash values.

At block 406, the system generates a plurality of image clusters by clustering the plurality of distance values. With reference to FIG. 6, the system clusters the difference values into Clusters 1-P. The Clusters 1-P can be seen as image clusters, as each difference value is associated with an image as described herein. Any suitable clustering algorithms can be used, such as: probabilistic clustering, K-means clustering, fuzzy C-means clustering, mean-shift clustering, hierarchical clustering, or any combination thereof.

In particular, probabilistic clustering comprises obtaining, for a particular difference value, probability values that it belongs to a particular cluster. In some examples, performing probabilistic clustering comprises performing unsupervised learning of finite mixture models (FMMs). In some examples, probabilistic modeling of distance distribution is performed through unsupervised learning of FMMs using an expectation maximization (EM) algorithm. An expectation-maximization algorithm is an iterative method to find (local) maximum likelihood or maximum a posteriori (MAP) estimates of parameters in statistical models, where the model depends on unobserved latent variables. The EM iteration alternates between performing an expectation (E) step, which creates a function for the expectation of the log-likelihood evaluated using the current estimate for the parameters, and a maximization (M) step, which computes parameters maximizing the expected log-likelihood found on the E step. These parameter-estimates are then used to determine the distribution of the latent variables in the next E step.

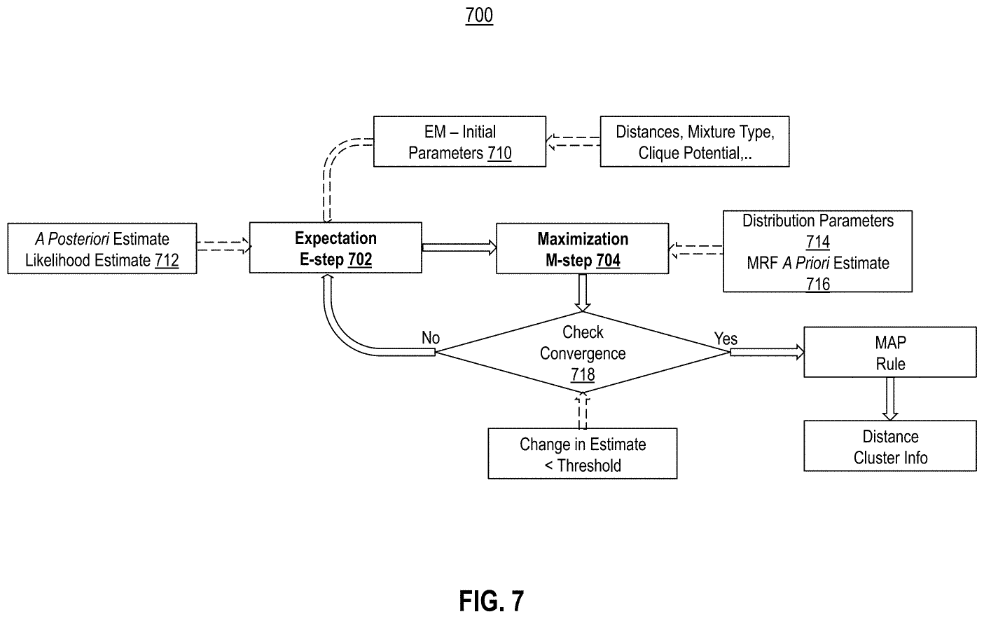

FIG. 7 illustrates an exemplary process 700 for performing probabilistic modeling or EM algorithm for unsupervised learning of finite mixture models, in accordance with some examples. As depicted, an exemplary system (e.g., one or more electronic devices) receives initial parameters 710. Performing expectation-maximization clustering can comprise (A) performing an expectation step 702 to obtain an a posteriori probability 712 for each cluster of a predefined number of clusters, (B) performing a maximization step 704 to obtain one or more parameters for each cluster of the predefined number of clusters, and (C) repeating steps (A)-(B) until a convergence is reached. The one or more parameters obtained in step (B) can comprise one or more distribution parameters 714. For a Gaussian distribution, the distribution parameters are mean and variance. For a Poisson distribution, the distribution parameter is λ.

Performing the maximization step may further comprise calculating one or more prior probability values (e.g., a priori probability value(s)) for each cluster of the predefined number of clusters. The one or more prior probability values can include a spatial Markov Random Field (“MRF”) prior 716 estimated from the a posteriori probability. Thus, spatial relationship between consecutive distances is modeled using MRF, which incorporates a smoothing term while computing a priori value(s) in each EM step.

Upon EM convergence at 718, the system assigns each difference value of the plurality of difference values (e.g., each of difference values in FIG. 6) to one of the plurality of image clusters (e.g., one of the clusters 1-P in FIG. 6) based on the maximum a posteriori (MAP) rule. In some examples, MAP rule is applied on a posteriori probabilities to obtain a cluster label for each distance metric. With reference to FIG. 6, the system can select Image 1 by default. The system can then identify the cluster allocation of Difference Value 1, which is computed comparing Hash Value 1 and Hash Value 2 and is associated with Image 2, as described above. If Different Value 1 falls under a selected cluster, then Image 2 is selected. As another example, the system can identify the cluster allocation of Difference Value 2, which is computed comparing Hash Value 2 and Hash Value 3 and is associated with Image 3. If Different Value 2 falls under a selected cluster, then Image 3 is selected.

At block 404, the system selects one or more image clusters from the plurality of image clusters. With reference to FIG. 6, the system selects a subset of clusters (i.e., clusters 610) from Clusters 1-P (i.e., clusters 608). In some examples, the system first orders the clusters 608. The re-ordering can be based on the mean values of the clusters, such as mean values of the cluster distribution parameters. The system then computes a cluster histogram based on the ordered list of clusters, and identifies a threshold to split the ordered list of clusters into selected clusters and unselected clusters so that a target frame rate can be achieved using the selected clusters, as described below. In some examples, the system labels images in the selected clusters with 1 and images in the unselected clusters with 0.

At block 404, the system produces the subset of surgical images from the series of video images using the selected one or more image clusters from the plurality of image clusters. In some examples, the first image of the series of video images is always included in the subset of surgical images by default. For example, with reference to FIG. 6, Image 1 is always included in the subset of surgical images 612. In some examples, in addition to the first image, all images in the selected clusters (e.g., selected clusters 610) are included in the subset of surgical images. In an exemplary implementation, each image in the series of images after the first image is marked either 1 (indicating that it belongs to a selected cluster) or 0 (indicating that it does not belong to any selected cluster). The system then selects the first image by default, and all following images with the label 1.

In some examples, one or more images not from the selected clusters 610 may be included in the final subset of surgical images 612. In some examples, after the system adds the first image and the images from the selected clusters 610 into the subset of surgical images 612, the system then determines if additional images should be included in the subset 612 based on a minimum frame selection window, which may be specified by a user. The goal of the minimum frame selection window is to ensure that no two consecutive images in the final subset 612 are apart by more than the minimum frame selection window in the original series of images 602. For example, if the minimum frame selection window is specified to be 10 seconds, the system can examine the original series of images (e.g., image series 602 in FIG. 6) and, whenever it discovers a 10-second period in which no image belongs to the selected clusters 610, selects an image from that 10-second period to be included in the final subset 612. In other words, if the minimum frame selection window is 10 seconds, the system will ensure at least one image within any 10-second window in the original series of images 612 is included in the final subset 612 to maintain some level of continuity between consecutive images in the final subset 612.

An image having artifacts or noise may be inadvertently included in the subset of images because of its large variance from neighboring images. Thus, in some examples, the system ensures that the subset of surgical images 612 does not include any images comprising a motion artifact or noise. For example, the system can determine whether an image in the subset of surgical images comprises a motion artifact or noise. In accordance with a determination that the image comprises a motion artifact or noise, the system can remove the image from the subset of surgical images, repair the image, and/or replace the image with another image from the video (e.g., another image from the same cluster). In some examples, how the abnormal images are handled can be configurable automatically or by a user. For example, in some scenarios, the system can be configured to keep the noisy images along with the normal ones, to improve the robustness of a downstream training algorithm. For example, instead of discarding or repairing it, the system may also keep it alongside another image from the same cluster that is closest to the noisy image but is deemed to be of good quality.

In an exemplary implementation, an input series of images is a 5-minute video at 30 frames per second (fps), with a total of 9000 frames (5×60×30). The target frame rate is 1 fps, meaning that the desired number of images in the final subset should be around 300 (9000× 1/30). By performing the process 400, clusters are ordered with increasing means, and the threshold is set so that total number of images falling under the selected clusters based on the threshold is equal to or slightly more than the targeted output frame count (i.e., 300). If a minimal frame selection window is selected (e.g., 60 s), additional frames are selected so that at least one frame is selected within that period (e.g., 60 s) from the input series of images.

The subset of images obtained by process 400 can be used to train a machine-learning model. The machine-learning model can be any machine-learning model that is configured to receive one or more surgical images and provide an output, such as a machine-learning model configured to receive a surgical image and detect objects and/or events in the surgical image. Rather than using all images of a video (e.g., 9000 images in the exemplary implementation above) to train the model, only a subset of images (e.g., 300 images in the exemplary implementation above) needs to be provided to the machine-learning model to train the model. The subset of images may be equally or more effective at training the model because it includes the representative images in the video, such as the examples depicted in FIG. 5, without including duplicative images to create bias in the model. At the same time, the required time, the processing power, and the computer memory to train the model can be significantly reduced due to the smaller number of training images. In some examples, the deduplication process 400 can be used for data reduction and missing frames can be generated from reduced data using generative models.

The subset of images obtained by process 400 can be processed by an algorithm to analyze the surgical operation. Rather than providing an entire video stream to the algorithm (e.g., 9000 images in the exemplary implementation above), only the subset of images (e.g., 300 images in the exemplary implementation above) can be provided to the algorithm. The subset of images does not compromise the quality of the analysis because it includes the representative images in the original video. At the same time, the required time, the processing power, and the computer memory to conduct the analysis can be significantly reduced due to the smaller number of images that need to be processed.

An algorithm can be used to process the subset of images and automatically identify events depicted in the subset of images. The system can then store an association between a given event and the timestamp of the image(s) depicting the given event for a later lookup. For example, a surgeon may want to review at a particular event or phase of surgery (e.g., a critical view of safety in laparoscopic cholecystectomy). Based on the event, the system can identify the timestamp(s) associated with the event and retrieve the image(s) for a quick review rather than requiring the surgeon to view the entire video to find the event.

In some examples, the subset of images obtained by process 400 can be displayed on a display. If a medical practitioner would like to review a surgery, he or she can simply review the subset of images (e.g., as a shorter series of images or as a shortened video). Accordingly, the review time can be significantly reduced without compromising the thoroughness of the review.

In some examples, the system can use the size of the generated clusters as a proxy for the scene prevalence in the given video. For example, when a subset of images has been selected, the system can attach a metadata value to each image, indicating what relative portion of the video this particular scene persists. This can be a useful statistics for data distribution estimation (e.g., 70% of the procedural video is spent on scene assessment without any intervention).

While process 400 involves processing a series of images to obtain a subset of images, it should be appreciated that the process 400 can be applied to process a series of videos to obtain a subset of videos. In some examples, process 400 can be performed real time during a surgery. The extracted subset of images can be saved locally for display and/or uploaded through a network for downstream analyses (e.g., training machine-learning models).

The foregoing description, for the purpose of explanation, has been described with reference to specific examples or aspects. However, the illustrative discussions above are not intended to be exhaustive or to limit the invention to the precise forms disclosed. For the purpose of clarity and a concise description, features are described herein as part of the same or separate variations; however, it will be appreciated that the scope of the disclosure includes variations having combinations of all or some of the features described. Many modifications and variations are possible in view of the above teachings. The variations were chosen and described in order to best explain the principles of the techniques and their practical applications. Others skilled in the art are thereby enabled to best utilize the techniques and various variations with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

What is claimed is:

1. A method for obtaining a subset of surgical images from a series of video images of a surgery, comprising:
hashing image data for each image of the series of video images of the surgery to obtain a series of hash values;
calculating a plurality of difference values for the series of hash values, each of the plurality of difference values indicative of a difference between two consecutive hash values in the series of hash values;
generating a plurality of image clusters by clustering the plurality of difference values;
selecting one or more image clusters from the plurality of image clusters; and
producing the subset of surgical images from the series of video images using the selected one or more image clusters from the plurality of image clusters.

2. The method of claim 1, wherein the series of video images is captured by an endoscopic imaging system.

3. The method of claim 1, wherein the series of video images is captured by an open-field imaging system.

4. The method of claim 1, wherein the subset of surgical images includes an image depicting an event in the surgery.

5. The method of claim 4, wherein the subset of surgical images includes a single image depicting the event in the surgery.

6. The method of claim 4, wherein the event comprises: introduction of a surgical tool, removal of the surgical tool, movement of the surgical tool, identification of anatomical landmarks during surgery, critical view of safety in laparoscopic cholecystectomy, identification of critical structures during surgery, removal of organs, navigating through tissue structures as part of preparation, monitoring suture, checking for extravasation or leakage (blood, bile, or other fluids), cauterization, clipping, cutting, or any combination thereof.

7. The method of claim 1, further comprising: training a machine-learning model based on the subset of surgical images from the series of video images.

8. The method of claim 7, wherein the machine-learning model is a generative model, the method further comprising: generating one or more images using the trained machine-learning model.

9. The method of claim 1, further comprising: displaying the subset of surgical images from the series of video images.

10. The method of claim 1, further comprising:
detecting an event in an image in the subset of surgical images; and
storing a timestamp associated with the image.

11. The method of claim 1, wherein each hash value of the series of hash values is an N-bit binary representation.

12. The method of claim 1, wherein hashing image data for each image of the series of video images of the surgery comprises:
reducing the resolution of each image in the series of video images; and
after reducing the resolution, applying a hash algorithm to the image to obtain a corresponding hash value.

13. The method of claim 12, wherein the hash algorithm comprises: an average hash algorithm, a difference hash algorithm, a perceptual hash algorithm, a wavelet hash algorithm, a locality-sensitive hash algorithm, or any combination thereof.

14. The method of claim 1, wherein each difference value of the plurality of difference values is a Hamming distance.

15. The method of claim 14, wherein the Hamming distance between two hash values is computed by performing a bit-wise OR operation between the two hash values.

16. The method of claim 1, wherein clustering the plurality of difference values comprises performing probabilistic clustering, K-means clustering, fuzzy C-means clustering, mean-shift clustering, hierarchical clustering, or any combination thereof.

17. The method of claim 16, wherein performing probabilistic clustering comprises performing unsupervised learning of finite mixture models (FMMs).

18. The method of claim 16, wherein performing probabilistic clustering comprises:
(A) performing an expectation step to obtain an a posteriori probability for each cluster of a predefined number of clusters;
(B) performing a maximization step to obtain one or more parameters for each cluster of the predefined number of clusters; and
(C) repeating steps (A)-(B) until a convergence is reached.

19. The method of claim 18, wherein the one or more parameters comprises one or more distribution parameters.

20. The method of claim 18, wherein performing the maximization step further comprises calculating one or more prior probability values for each cluster of the predefined number of clusters.

21. The method of claim 20, wherein the one or more prior probability values include a spatial Markov Random Field (“MRF”) prior estimated from a posterior probability.

22. The method of claim 1, wherein selecting one or more image clusters from the plurality of image clusters comprises:
assigning each difference value of the plurality of difference values to one of the plurality of image clusters based on the maximum a posteriori (MAP) rule; and
ordering the plurality of image clusters.

23. The method of claim 1, wherein the first image of the series of video images is included in the subset of surgical images by default.

24. The method of claim 1, further comprising:
receiving a minimum frame selection window; and
including one or more images from an unselected image cluster to the subset of surgical images based on the minimum frame selection window.

25. The method of claim 1, further comprising: determining whether an image in the subset of surgical images comprises a motion artifact or noise.

26. The method of claim 25, further comprising: in accordance with a determination that the image comprises a motion artifact or noise, removing the image from the subset of surgical images.

27. The method of claim 25, further comprising: in accordance with a determination that the image comprises a motion artifact or noise, repairing the image.

28. The method of claim 25, further comprising: in accordance with a determination that the image comprises a motion artifact or noise, including the image in the subset of surgical images.

29. A system for obtaining a subset of surgical images from a series of video images of a surgery, comprising:
one or more processors;
one or more memories; and
one or more programs, wherein the one or more programs are stored in the one or more memories and configured to be executed by the one or more processors, the one or more programs including instructions for:
hashing image data for each image of the series of video images of the surgery to obtain a series of hash values;
calculating a plurality of difference values for the series of hash values, each of the plurality of difference values indicative of a difference between two consecutive hash values in the series of hash values;
generating a plurality of image clusters by clustering the plurality of difference values;
selecting one or more image clusters from the plurality of image clusters; and
producing the subset of surgical images from the series of video images using the selected one or more image clusters from the plurality of image clusters.

30. A non-transitory computer-readable storage medium storing one or more programs, the one or more programs comprising instructions for obtaining a subset of surgical images from a series of video images of a surgery, which when executed by one or more processors of an electronic device, cause the electronic device to:
hash image data for each image of the series of video images of the surgery to obtain a series of hash values;
calculate a plurality of difference values for the series of hash values, each of the plurality of difference values indicative of a difference between two consecutive hash values in the series of hash values;
generate a plurality of image clusters by clustering the plurality of difference values;
select one or more image clusters from the plurality of image clusters; and
produce the subset of surgical images from the series of video images using the selected one or more image clusters from the plurality of image clusters.
